(19) United States
(12) Patent Application Publication
(10) Pub. No.: US 2023/0220837 A1
(43) Pub. Date: Jul. 13, 2023

(54) PERFORMANCE AMPLIFICATION OF SUPER-ELASTIC AND SHAPE MEMORY ACTUATOR DEVICES USING RESPONSE MODIFICATION WITH HYDRAULIC AND PSEUDO HYDRAULIC MEANS

(71) Applicant: Alfred R. Austen, Bath, PA (US)

(72) Inventor: Alfred R. Austen, Bath, PA (US)

(21) Appl. No.: 18/113,871

(22) Filed: Feb. 24, 2023

Related U.S. Application Data
(63) Continuation of application No. 16/869,145, filed on May 7, 2020, now abandoned.
(60) Provisional application No. 62/845,424, filed on May 9, 2019.

(51) Int. Cl. F03G 7/06; F15B 5/00

(52) U.S. Cl. CPC F03G 7/0614; F15B 5/00

(57) ABSTRACT

Hydraulic or pseudo hydraulic methods and apparatus using component area ratios to amplify the displacement or force responses of super-elastic (SE) and shape memory actuator (SMA) devices by means mechanically coupled to the SE/SMA devices.

### BACKGROUND OF THE INVENTION

Super-elastic (SE) and shape memory actuators (SMA) devices often use long slender members such as wire, rod or strips (hereafter individually and collectively referred to as wire) that change in length as they respond within a device in order to perform a force and/or displacement function. These length changes are relatively small and typically range up to 10% for wire used in tension and 5% for wire used in uniaxial compression. U.S Pat. No. 10,221,837, discloses and claims apparatus and methods for supporting a slender member having high axial compression stress state during a change in length of the member. The changes in length of the wires in the SE/SMA devices are accompanied by high axial stresses of up to compression yield strength of the wire which represent high forces, for example up to 150 pounds-force in a 1/1000 square inch cross-section wire with a diameter of 0.0357 inches. However, the associated change in length is relatively small, only a few percent of the wire's length. While high force, low displacement SE/SMA devices have found many applications, a much broader range of force-displacement combination would be very desirable for varying applications.

### SUMMARY OF THE INVENTION

Method and apparatus for achieving the amplification of displacement or force in SE/SMA devices using hydraulic or pseudo hydraulic operated assemblies with component area ratios to achieve the performance amplification and fulfil the desire for a more compact, lightweight, inexpensive and flexible devices. These assembles are mechanically coupled with the SE/SMA devices and they are called performance amplifiers. The invention of the performance amplification may also provide methods of using larger diameter, higher force SE/SMA wires in new devices that provide combined high force and large displacement.

### BRIEF DESCRIPTION OF THE DRAWINGS

The detailed description of the invention will be better understood when read in conjunction with the appended drawings. For the purpose of illustrating the invention, there is shown in the drawings certain embodiments of the present invention. It should be understood, however, that the invention is not limited to the precise arrangements and instrumentalities shown in the drawings.

FIG. 1 is a schematic representation of an example of dynamic anti buckling lateral support using a confining tube to support the wire in combination with a rigid load transfer pin according to the prior art.

FIG. 2a is a schematic cross-sectional representation of a functioning design of spring plunger conFIGuration using the dynamic anti buckling lateral support using a confining tube to support the wire in combination with a rigid load transfer pin, according to the prior art.

FIG. 2b is a photograph of the spring plunger conFIGuration described in FIG. 2a.

FIG. 3 is a copy of graphical display image of the recorded data acquisition operating load-displacement test characterizing cyclic loading performance of the device described in FIG. 2b.

FIG. 4a is a schematic cross-sectional representation of the present invention applied to a performance amplifier attached to the spring plunger device described in FIG. 2a.

FIG. 4b is a schematic cross-sectional representation of the present invention applied to a variation of the performance amplifier described in FIG. 4a.

FIG. 4c is a schematic cross-sectional representation of the present invention applied a further variation of the performance amplifier described in FIG. 4a.

FIG. 5a is a schematic cross-sectional view of a performance amplifier operated using hydraulic fluid pressure that is coupled to a spring plunger using the dynamic anti buckling lateral support using a confining tube to support the wire in combination with a rigid load transfer pin.

FIG. 5b is a photograph of the performance amplifier coupled with the spring plunger described in FIG. 5a.

FIG. 5c is a copy of graphical display image of the recorded data acquisition operating load-displacement test characterizing performance of the device described in FIG. 5a.

FIG. 6a is a schematic cross-sectional representation of a performance amplifier operated using soft elastomer as a pressure transmitting pseudo hydraulic pressure medium that is coupled with a spring plunger conFIGuration using the dynamic anti buckling lateral support using a confining tube to support the wire in combination with a rigid load transfer pin.

FIG. 6b is a copy of graphical display image of the recorded data acquisition operating load-displacement test characterizing performance of the device described in

FIG. 6a and a comparison load-displacement test of the SE/SMA device without performance amplification.

FIG. 7 is a schematic cross-sectional representation of a performance amplifier operated to amplify the force output of the device.

FIG. 8 is a schematic illustration of a hydraulic performance amplification device that uses the SE/SMA wire acting in tension.

### DETAILED DESCRIPTION OF THE INVENTION

The present invention provides a means called a “performance amplifier” to change the mechanical operating output of force and displacement of mechanically coupled SE/SMA device by a chosen ratio factor, R, such that when one output parameter, force or displacement is changed by the performance ratio factor, R, the other is changed by the reciprocal of the ratio factor, which is 1/R. For example, if the displacement output is increased by a factor of 4, the associated force output is decreased by a factor of 4. This result is achieved by having the SE/SMA device output act on a movable component in the performance amplifier with an area exposed to the pressure of a pressure transmitting medium and by having the performance amplifier device possess a movable output component with an area exposed to the same pressure transmitting medium. The ratio of the SE/SMA device output contact component area exposed to the pressure transmitting medium to the performance amplifier device output component area exposed to the pressure transmitting medium creates the performance ratio factor, R. The SE/SMA wire device may be designed and constructed so that the SE/SMA wire may be acting either in axial tension or compression to create the desired force and displacement output.

The performance amplifier must have, but is not limited to having, the following features: (a) means to rigidly attach to a SE/SMA device or other force and displacement operating devices; (b) a movable component that is subject to the force and displacement output of the SE/SMA device and which contacts a pressure transmitting medium; (c) a movable component that transmits the force and displacement output of the performance amplifier and which also contacts the same pressure transmitting medium; (d) a housing that contains the pressure transmitting medium with the means to prevent the escape of the pressurized medium; (e) a pressure transmitting medium that is a fluid or very soft solid that can transmit pressure from one location to another with a low pressure gradient; and (f) the sizing of the contact areas of the aforementioned movable components to create the desired performance ratio factor, R.

Compact, lightweight performance amplifying devices were constructed and satisfactorily operated using pressure transmitting mediums of molybdenum disulfide mixed with petroleum jelly, often called moly paste, (hydraulic mode) and grease lubricated soft neoprene elastomer (pseudo-hydraulic mode). The fabricated devices that are described were designed to be constructed from readily available materials and components. Further modified construction will be possible with further development as is also the case for their performance and durability.

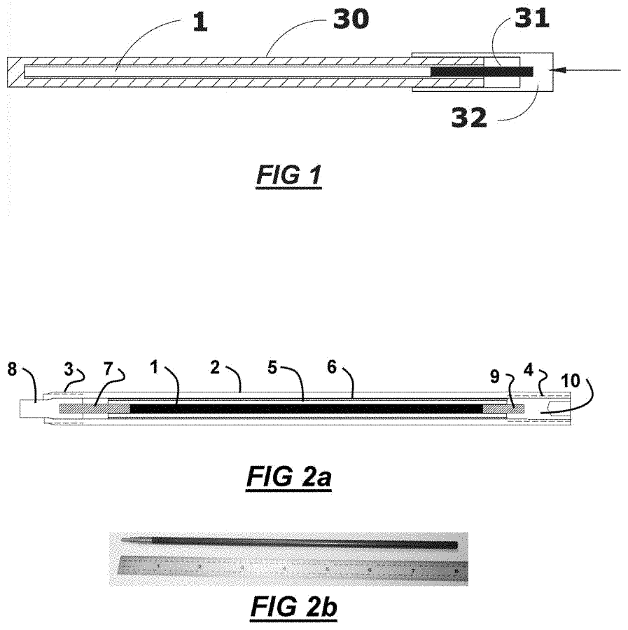

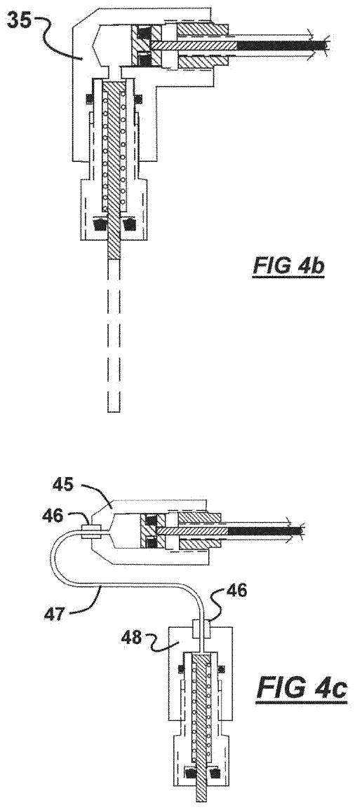

One category for which increased force-displacement combinations would be especially useful is for devices using a wire having high axial compression stress state during a change in length. Such devices typically operate with a combination of very high force and relatively low displacement. FIG. 1 is a copy of FIG. 4 from U.S. Pat. No. 10,221,837 and shows the use of a SE/SMA Wire 1 in compression inside a Stationary Lateral Support 30 and loaded using a Load Pin 31. Such a device was constructed as shown in FIG. 2a.

In FIG. 2a, Nitinol #1 Wire 1, obtained for Fort Wayne Metals, is 0.050 inches in diameter by 6.0 inches long and was supported inside by the combination of the outer, 0.187 inch outside diameter (OD) by 0.118 inch inside (ID) steel Support Shell 2 with inner Support Tubes 5 and 6 having with OD by ID dimensions in inches of 0.094 by 0.054 and 0.115 by 0.095 respectively. One end of Shell 2 was formed into a conical shape to reduce the ID for restraining Force Stem 8 and was threaded externally with 10-32 Threads 3 over ⅝ inches in length. The other end of Shell 2 was threaded internally with 6-40 Threads 4 over ½ inch in length. Load Pin 7, which is hardened 0.052 inch diameter drill rod, fits into a matching cavity in force stem 8 and transfers forces and displacements to Wire 1. Load Pin 9, which is hardened 0.052 inch diameter drill rod, fits into a matching cavity in ⅜ inch long Set Screw 10 and supports the other end of Wire 1. Component lengths are adjusted to allow for a 0.25 inch stroke of force stem 8. FIG. 2b is a photograph of an SE/SMA device fabricated according to FIG. 2a in the form of a spring plunger.

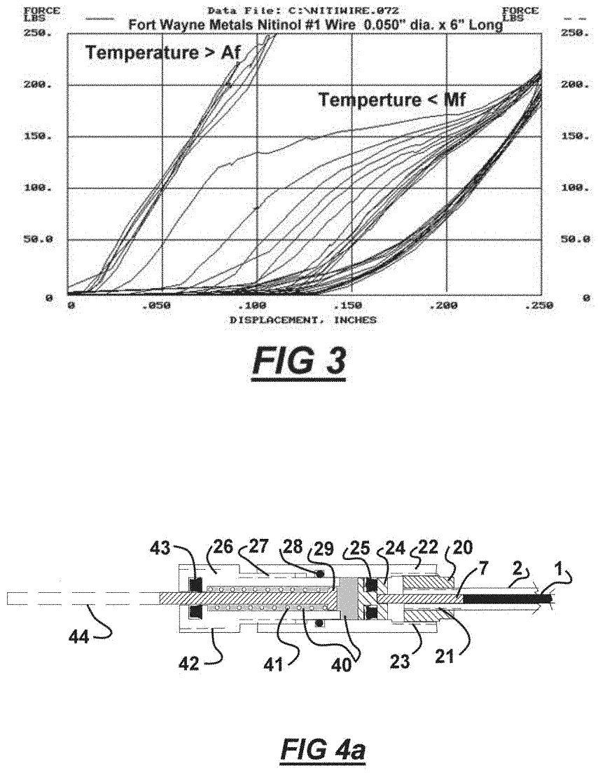

FIG. 3 shows the recorded data acquisition operating load-displacement test characterizes of the device described in FIG. 2a and shown in FIG. 2b The repeated axial compression loading and unloading of the 6 inch long Nitinol 0.05 inch diameter by Wire 1 in this device was performed at two temperature ranges, one was above the austenite finish temperature (Af) and one was below the martensite finish temperature (Mf) of the wire. The wire was heat treated at 500C prior to testing. The important feature of these data for the purpose of the invention described herein is the combination of high force, up to 250 pounds-force and low displacements, 0.10 inches and less. It was recognized that for many applications, the combination of a lower force with a larger displacement would be advantageous. These combinations can be achieved using mechanical leverage means. However, such systems require structurally substantial components such as a lever arm and a supported pivot mechanism.

FIG. 4a is a cross-sectional view of a performance amplifier that is coupled with a spring plunger as described in FIG. 2a. The components of the portion of spring plunger that are shown are the SE/SMA Wire 1, Support Shell 2 and Load Pin 7. The threaded end of the Support Shell 2 is screwed into the Threads 21 of the Coupling Bushing 20 which in turn is connected to Cylinder Housing 22 with the threaded connection 23 such that the Load Pin 7 abuts the Piston 24. Piston 24 has a close sliding fit inside the smooth bore portion of Cylinder Housing 22 and contacts a high pressure fluid Seal 25. Seal 25 is a Poly-Parks type U-cup seal with a ⅛ “ID and ⅜” OD having a pressure rating of 5,000 psi and shown in the McMaster-Carr catalog as part number 9505K11. The components 20 through 25 as an assembled group comprise the Pressurization Means. The next set of components 26 through 44 as an assembled group comprise the Response Means. The Response Housing 26 is secured to the Cylinder Housing 22 with the Threaded Connection 27 and O-ring 28 provides a fluid seal with Cylinder Housing 22. Output Stem 29 resides inside Response Housing 26 and Seal 43 is added to create a pressure tight cavity containing Fluid 40. Return Spring 41 positions the Output Stem 29 in the retracted position shown when there is no pressure in fluid 40. One mode of operation would be for Wire 1 to be actuated by heating and expand to push Piston 24 into the fluid 40 causing it to be pressurized which would act on Output Stem 29 causing it to move toward the indicated, full stroke Position 44. In this description, the Seal 25 has an OD of ⅜ inches and Seal 43, which is identical to Seal 25, has an ID of ⅛ inches so the area ratio of Piston 24 diameter to Force Stem 29 diameter is 9:1 causing the displacement of the Output Stem 29 to be 9 times that of the displacement of Piston 24.

The above described performance amplifier will operate as described. However, its design is presented by way of example and modified versions with different performance ratios can be and are intended to be included in the claimed invention. In later examples, 4;1 performance ratios performance amplifiers are presented with different design conFIGurations. Furthermore, conFIGuration variations of the FIG. 2a device are shown in FIGS. 4b and 4c. In the case of FIG. 4b, the modification is the reconFIGuration of Cylinder Housing 22 from arranging the Pressurization Means and Response Means which were axially inline to be rearranged so that the Pressurization Means and Response Means are axially at a right angle. In FIG. 4c, the Cylinder Housing 22 shown in FIG. 4a is divided into two components Cylinder Section 45 and Response Section 46 which are connected hydraulically by Hydraulic Tube 47 that attaches to each section using a Tube Fitting 46. These conFIGuration variations show the design flexibility offered by the performance amplifier described herein. Further expanding the application flexibility of the performance amplifier, the pressurization means shown in FIG. 4c may be connected to operate other hydraulically driven devices such as control heads on valves, hydraulic switching devices, locks and latches, etc. In addition, SE/SMA devices other than the spring plunger conFIGuration shown that can be mechanically connected to operate with the performance amplifier.

FIG. 7 is a schematic illustration of a force amplification device that is coupled with a SMA device having the construction illustrated in spring plunger as described in FIG. 2a. The components of the portion of spring plunger that are shown are the SE/SMA Wire 1, Support Shell 2 and Load Pin 7. The threaded end of the Support Shell 2 is screwed into the internal threads of the Connection Bushing 70 which in turn is connected to Cylinder Shell 71 with a threaded connection. Cylinder Shell 71 has external Threads 72 that are used to affix it to a support housing not shown. Force Piston 73 is a sliding fit in the smooth bore of Cylinder Shell 71 which creates the fluid filled Cavity 74. High pressure elastomer Pin Seal 75 and Shell Seal 76 along with O-ring Seal 77 prevent the fluid from escaping from Cavity 74. One mode of operation would be for Wire 1 to be actuated by heating and expand to push it into the fluid Cavity 74 causing the fluid to be pressurized which acts on Force Piston 73 causing it to move toward the Body 78 and apply contact force to Surface 79 on Body 78. The contact force applied to Surface 79 will be equal to the force with which Load Pin 7 pushes into the Fluid Cavity 74 multiplied by a factor equal to the squared ratio of the diameter of the Force Piston 73 divided by the diameter of the Wire 1. The above described force performance amplifier will operate as described. However, its design is presented by way of example and modified versions with different construction and performance ratios can be and are intended to be included in the claimed invention. By way of example, this device may be used for a variety of applications including but not limited to work piece clamping, clutch operation, break operation.

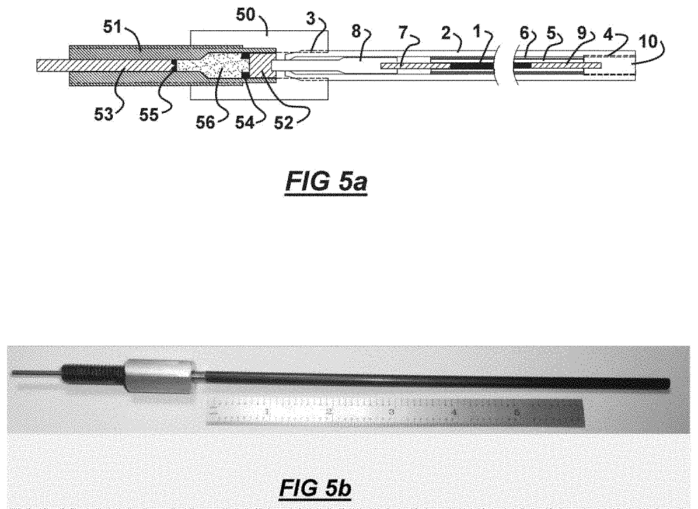

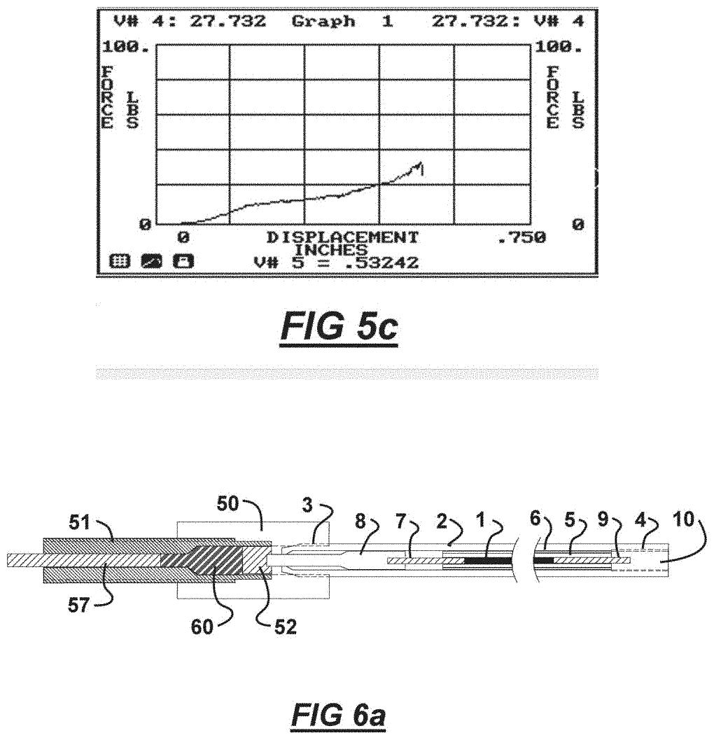

Example 1: This example describes the operation of a performance amplifier using a fluid medium to transmit the hydraulic pressure within the device and this feature is referred to as the hydraulic means. FIG. 5a is a cross-sectioned view of a performance amplifier that was fabricated, attached to the spring plunger described in FIG. 2a and tested. Parts 1 through 10 are identical to those previously described with the exception that the grade of Nitinol Wire 1 is Fort Wayne Metals Nitinol #6. The spring plunger was screwed into a Connector 50, a 10-32 by 5/16″-18 thread adapter (McMaster-Carr# 98434A106) that was altered by drilling from the 5/16″ thread side with a 0.274″ drill to break through into the 10-32 threaded cavity. A high strength 5/16′ thread 1.5 inch long socket head cap screw was modified to make Body 51 by: (a) machining the head down to make a 0.272″ diameter by ¼″ long reduced section; (b) Using a ball end mill, form a 3/16″ by ½″ deep cavity in the end with the 0.272″ reduced section; (c) Drilling through axially with a 0.0955 diameter drill; and (4) breaking the edge on the transition from the 3/16″ cavity to the 0.0955 hole with a 20 degree semi-cone angle tool and polish the transition section. Piston 52 is a 3/16″ diameter by 3/16″ long steel cylinder with a 3/32″ diameter by 1/16″ deep cavity milled into one face to accept the tip of the Force Stem 8. The Output Stem 53 is a 3/32 rod, 1.4 inches long with one end machined to accept a 1/32 width by dash number 001 Buna-N O-ring 55. The performance amplifier was assembled by inserting the 1/16″ width by dash Number 004 Buna-N X-Profile Ring 54 into the 3/16″ cavity in Body 51 followed by Piston 52 and screwing the Body 51 into the Connector 50 with the spring plunger in place. Using a large needle hypodermic syringe, the remaining 3/16″ diameter cavity was filled with the hydraulic fluid media, Moly Paste 56 so it extends about ¼41 into the 0.0955″ diameter bore. The assembly is completed by inserting the Output Stem 53 with the O-ring 55 into the 0.0955″ diameter bore of Body 51. A photograph pf the assembled unit is shown in FIG. 5b.

FIG. 5c shows the data acquisition recorded test trial data for the above hydraulically operated performance amplifier with an Output Stem 53 displacement of approximately ½ inch upon compression and reaching a force of about 30 pounds force. The compression force of 30 pounds force on the Output Stem 53 represents a Moly Paste 56 hydraulic pressure of approximately 4200 psi. A 4,200 psi hydraulic pressure acting on Piston 52 exerts a force of 116 pounds force on force Stem 8 causing it to axially compress Wire 1 by about ⅛ inches.

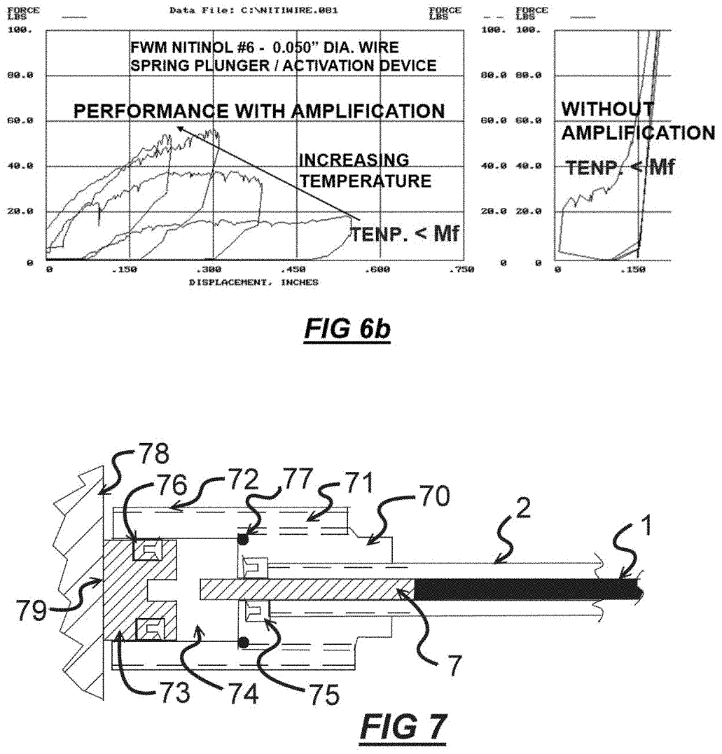

Example 2: This example describes the operation of a performance amplifier using an externally moly paste lubricated soft elastomer to replace the fluid media used to transmit the pressure within the device and this feature is referred to as the pseudo hydraulic means. FIG. 6a is a cross-section view of a performance amplifier that was fabricated, attached to the spring plunger described in FIG. 2a and tested. Parts 1 through 10 are identical to those previously described with the exception that the grade of Nitinol Wire 1 is Fort Wayne Metals Nitinol #6. The spring plunger was screwed into a Connector 50, a 10-32 by 5/16″-18 thread adapter (McMaster-Carr # 98434A106) that was altered by drilling from the 5/16″ thread side with a 0.274″ drill to break through into the 10-32 threaded cavity. A high strength 5/16′ thread socket head cap screw was modified to make Body 51 by: (a) machining the head down to make a 0.272″ diameter by ¼″ long reduced section; (b) Using a ball end mill, form a 3/16″ by ½″ deep cavity in the end with the 0.272″ reduced section; (c) Drilling through axially with a 0.0955 diameter drill; and (4) breaking the edge on the transition from the 3/16″ cavity to the 0.0955 hole with a 20 degree semi-cone angle tool and polish the transition section. Piston 52 is a 3/16″ diameter by 3/16″ long steel cylinder with a 3/32″ diameter by 1/16″ deep cavity milled into one face to accept the tip of the Force Stem 8.

The Output Stem 57 is a 3/32 rod, 1.4 inches long with both ends machined with flat face ends. The performance amplifier was assembled by inserting two grease lubricated oil-resistant soft neoprene O-ring cord Elastomer 60 in the form of discs of 0.21″ diameter by 0.10″ thick followed by the Piston 52 into the 3/16″ cavity in Body 51 and screwing the Body 51 into the Connector 50 with the spring plunger in place. The assembly is completed by inserting the Output Stem 57 into the 0.0955″ diameter bore of Body 51.

FIG. 6b shows the data acquisition recorded test trial for the above pseudo hydraulically operated performance amplifier with an Output Stem 57 displacement of approximately ½ inch upon compression and reaching a force of about 18 pounds force. For comparison, the recorded data graph of the FIG. 2a spring plunger force-displacement behavior without performance amplification which is positioned to the right in FIG. 6b shows reaching a 30 pound compression force at only 0.10 inches displacement. In the test with the Wire 1 at a temperature below the martensite finish temperature, Mf, the compression force of 18 pounds force on the end of Output Stem 57 was reached at a displacement of approximately ½ inch and represents the pressurization of Elastomer 60 to approximately 2500 psi on the end of Output Stem 57. This displacement observation of ½ inch with performance amplification as compared to about ⅛ inch displacement for the test without performance amplification shows the successful performance of this performance amplification device. The additional compression trials given in FIG. 6b at higher temperatures show increasing force with reduced displacement, which was reduced to avoid over pressurization, as the Wire 1 changed in properties. The highest force on Output Stem 57 was 55 pounds force which represents the pressurization of Elastomer 60 to approximately 7,700 psi on the end of Output Stem 57. The observed drop in the pressure reading without a change in displacement reading upon loading reversal of about 40% of the peak pressure suggest a pressure attenuation of about 20% between the Piston 52 and Output Stem 57 caused by the friction and shear stresses within the elastomer. By this reasoning, the peak pressure on Piston 52 was 80% of 7,700 psi or 6,200 psi which translates into a force of 172 pounds force or an axial compression stress in Wire 1 of 86 psi. These test results show the viability of using a lubricated soft elastomer in place of a hydraulic fluid medium as the pressure transmitting media in a performance application device.

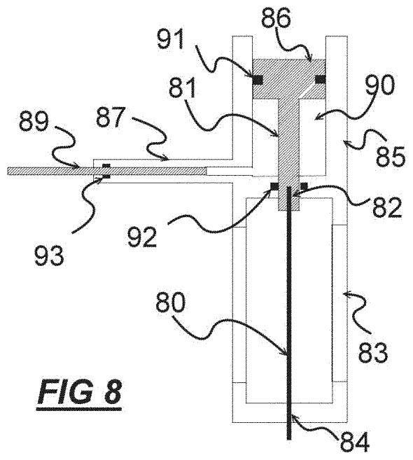

FIG. 8 is a schematic illustration of a hydraulic performance amplification device that uses the SE/SMA Wire 80 acting in tension. One end of SE/SMA Wire 80 is attached to Piston Rod 81 at Location 82 and the other end is attached to Rigid Frame 83 at Position 84. Rigid Frame 83 is attached to Cylinder 85. Piston Rod 81 is attached to Piston 86 which slides smoothly in the bore of Cylinder 85. Hollow Protrusion 87 is attached to Cylinder 85 and Output Ram 89 slides freely in the bore of Hollow Protrusion 87. The Cylinder Cavity 90 communicates with the bore of Protrusion 87 and they are filled with a fluid which is confined using Piston Seal 91, Piston Rod Seal 92 and Output Ram Seal 93. Tension in Wire 80 causes Piston 86 to pressurize the said confined fluid which acts of the end of the Output Ram 89 to push on the Output Ram 89 and which transmits the force and displacement generated by SE/SMA Wire 80 force and the said displacement response that is transmitted through the said fluid. The Output Ram 89 force and displacement output response is related to SE/SMA Wire 80 force and displacement response in accordance with the ratio of the cross sectional area of Piston 86 in contact with said fluid to the cross section of the Output Ram 89 in contact with said fluid. This schematic illustration is one example of many possible design conFIGurations, all of which will have the same basic function to transmit the response from a SE/SMA wire acting in tensile mode to an output means using a hydraulically operated performance amplification device. Having thus described my invention what is desired to be secured is set forth in the appended claims.

1.-13. (canceled)

14. A hydraulic and pseudo-hydraulic performance amplification device for use with super-elastic and shape memory actuator (SE/SMA) devices having at least one SE/SMA wire in axial compression that is supported from buckling comprising:
means to rigidly attach the performance amplification device to a SE/SMA device.

15. A performance amplifier subject to force and displacement output from an SE/SMA device having at least one SE/SMA wire in axial compression comprising a hydrostatic pressure transmitting medium, movable means to transmit force-displacement output of the performance amplification device contacting said hydrostatic pressure transmitting medium, and means to contain and prevent escape of said hydrostatic pressure transmitting medium; with contact areas of said moveable components sized to create a desired performance amplification ratio factors.

16. A system for amplifying force-displacement response of a SE/SMA device by coupling said SE/SMA device with a hydraulic means comprising:
a. an SE/SMA device having a force-displacement response generated by the action of SE/SMA wire with axial compression stress and axial strain, and
b. hydraulic means comprised of a fluid confining device rigidly coupled to the said SE/SMA device where in the SE/SMA device force-displacement response is transmitted to pressurize said fluid in said hydraulic means by an SE/SMA device component in contact with said fluid, and wherein the resultant force-displacement output of said hydraulic means caused by said pressurized fluid acting on a movable component in said hydraulic means to transmit the force-displacement output whereby said output of the SE/SMA device is performance amplified.

17. A device according to claim 15 wherein said resultant force-displacement output is related to the force-displacement response generated by the action of SE/SMA wire by the performance ratio of the respective cross section areas of SE/SMA device component in contact with the said fluid to the hydraulic means force-displacement output movable component in contact with said pressurized fluid.

18. A system as set forth in claim 16 in which the amplified output response is displacement.

19. A system as set forth in claim 16 in which the amplified output response is force.

20. A system as set forth in claim 16 wherein axial stress and strain in said wire of the SE/SMA device is generated by temperature actuated phase change (SMA) wire behavior.

21. A system as set forth in claim 16 wherein axial stress and strain in said wire of the SE/SMA device is generated by super elastic (SE) wire behavior.

22. A system as set forth in claim 16 wherein said hydraulic means is a non-fluid hydrostatic pressure transmission medium.

23. A system as set forth in claim 21 in which the amplified output response is displacement.

24. A system as set forth in claim 21 in which the amplified output response is force.

25. A system as set forth in claim 16 wherein axial stress and strain in said wire of the SE/SMA device is generated by temperature actuated phase change (SMA) behavior.
